(19) United States
(12) Patent Application Publication
(10) Pub. No.: US 2020/0215848 A1
(43) Pub. Date: Jul. 9, 2020

(54) FLOCKED ARTICLE HAVING ARTISTIC TEMPLATES TO RECEIVE COLORS

(71) Applicant: Parker Alexander, South Lake Tahoe, CA (US)

(72) Inventor: Parker Alexander, South Lake Tahoe, CA (US)

(21) Appl. No.: 16/825,747

(22) Filed: Mar. 20, 2020

Related U.S. Application Data
(60) Provisional application No. 62/977,491, filed on Feb. 17, 2020.

(51) Int. Cl. B44C 1/10; B32B 7/12; B32B 5/02; A41D 27/08; A42B 1/00; B32B 5/26

(52) U.S. Cl. CPC B44C 1/105; B32B 7/12; B32B 5/02; A41D 27/08; B32B 2307/748; B32B 5/26; B32B 2451/00; B32B 2260/021; A42B 1/004

(57) ABSTRACT

The present invention is directed to a novel flocked article for personalizing consumer articles, such as clothing, bags, and like. The flocked article comprises a flocked design layer and a base layer, the flocked design layer embedded to a top surface of the base layer, wherein the top surface of the base layer is adapted to receive colors. The flocked design layer having at least one flocked design template into which one more different colors can be filled.

### CROSS-REFERENCE TO RELATED APPLICATIONS

This application claims priority to the U.S. provisional patent application Ser. No. 62/977,491 filed Feb. 17, 2020 which is incorporated herein by reference in its entirety.

### FIELD OF INVENTION

The present invention relates to a flocked article and, more particularly, to a flocked article having flocked artistic designs for receiving colors.

### BACKGROUND

Consumer goods such as clothing, bags, hats, wallet, pillows, and like are generally ornamented with artistic designs. Creative artistic designs are applied to consumer goods to increase their aesthetic value. The creative artistic designs could be based on human imaginations inspired by nature, celestial bodies, animals, and like. These creative artistic designs can be applied to articles in multiple known ways for exampling imprinting, stitching, pasting, and like.

There has been an increasing trend nowadays for personalized designs provided on consumer goods. Consumers are increasingly demanding to customize goods based on their imaginations and creativity. For example, a consumer can upload a digital image of the design to the manufacturer of the shirt, wherein the manufacture applies the personalized digital image to the shirt. Thus, a continuous need is appreciated for an improved and unique way to personalize consumer goods/articles.

### SUMMARY OF THE INVENTION

The principal objective of the present invention is therefore directed to a novel flocked article that allows a user to personalize an article.

It is an additional objective of the present invention that the novel flocked article can be embodied on different types of consumer articles.

It is yet another objective of the present invention that the novel flocked article is economic to manufacture and easy to use.

In one aspect, the present invention is directed to a novel flocked article comprising a flock design layer and a base layer, wherein the flocked design layer can be embedded to a surface to the base layer, the surface of the base layer adapted to receive color. The flocked design layer comprises at least one design template into which different colors can be applied. The design template can be based on any creative designs, such as animal figures, nature, celestial bodies and like. In one aspect, the design template can be a line drawing into which the different colors can be filled.

In another aspect, the novel flocked article can be applied to a consumer article, such as clothing, hat, shoes, wallet, bags, and like. To apply the novel flocked article on the consumer article, the rear surface of the bottom layer can be provided with an adhesive layer. The adhesive layer can be protected with a release liner.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a top view of the flocked article, in accordance with an embodiment of the present invention.

FIG. 2 is a side view of the flocked article of FIG. 1, in accordance with an embodiment of the present invention.

FIG. 3 is a flow chart showing a method, in accordance with an embodiment of the present invention.

FIG. 4 is a flow chart showing a method, in accordance with an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

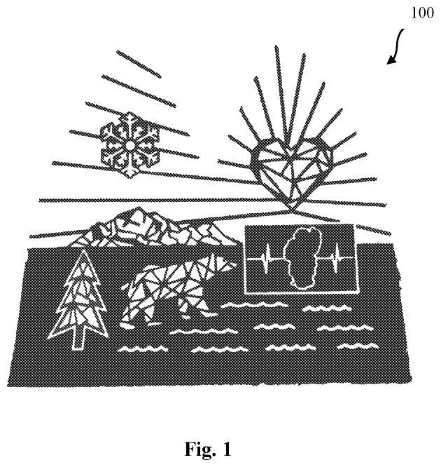

The present invention is directed to a novel flocked article for personalizing a user's good/article. As shown in FIGS. 1 & 2, the novel flocked article 100 comprises a flocked design layer 110 embedded to a base layer 120. As can be seen in FIG. 1 the flocked design layer 110 can have different design templates into which different colors can be applied. FIG. 1 shows line drawings based on flowers, animal characters, trees, mountains, celestial bodies, and like creative designs. Into such line drawings different colors can be filled, for example, color markers, oil paints, etc. can be filled into the design template. Different colors can be filled by a user based on his desire or imagination. Flocked design layer having the design templates can be flocked to the top surface of the base layer, such that colors filled into the design templates can be applied to the top surface of the base layer. Accordingly, the top surface of the base layer can be adapted to removably receive the colors.

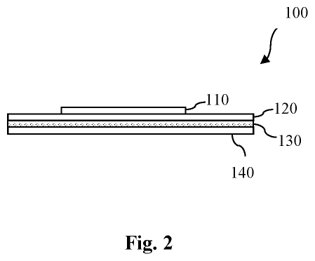

Further shown in FIG. 2 and described below is an adhesive layer 130 and a liner 140. The adhesive layer 130 can be applied to the bottom surface of the base layer 120 for coupling the flocked article 100 to any user's article, such as consumer goods. The adhesive can be any adhesive known to a skilled person, such as pressure-based adhesives and heat-based adhesives. The adhesive layer 130 can be protected by a release liner 140, wherein the liner 140 can be removed to expose the adhesive layer 130. Alternatively, the flocked article 100 having the flocked design layer 110 and the base layer 120 can be stitched to the user's article. The base layer 120 can be made of a fabric material that can receive color from a color marker or paint.

In an exemplary embodiment, the base layer can be configured to removably receive the colors. Desired colors can be applied to the flocked article by the user. However, the applied colors may not be permanent, such as the user can remove the colors from the flocked article and re-apply desired colors to the flocked article. Furthermore, the colors can be applied to the flocked article which is coupled to the consumer article. For example, the colors can be removed by rubbing-off the colors with a solvent, such as alcohol. Alternatively, the colors can be washed off from the flocked article by washing the flocked article with water and detergent. Also, are known such colors that can be removed by solvents or washing with detergent. It is to be noted that the embodiment describes applying removable colors to the flocked article, it is within the scope of the present invention that colors can be permanently applied to the flocked articles. Permanent colors are known in the art for applying to fabrics.

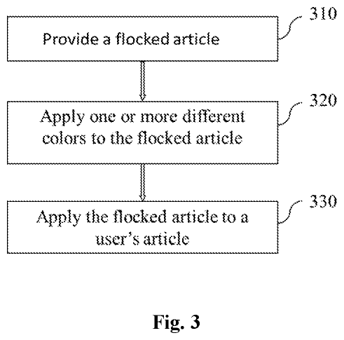

FIG. 3 is a flow chart showing an exemplary method of the present invention. At step 310, the flocked article can be provided to the user. The flocked article can be available in different designs from which the user can choose the desired design. The user can then fill one or more different colors to different design templates which are configured in the flocked design layer of the flocked article. The different colors can be filled into the templates. For example, green color can be filled in the tree-shaped design template. Similarly, brown color can be applied to the mountain-shaped design template. At step 330, the flocked article can then be applied to any user's article, for example, to the clothing, shoes, bags, wallet, and like. To apply the flocked article to the user's article, the adhesive liner can be removed from the flocked article and thereafter the flocked article can be applied to the user's article. Depending on the type of coupling mechanism provided, the flocking article can stick with an adhesive or stitch to the user's article.

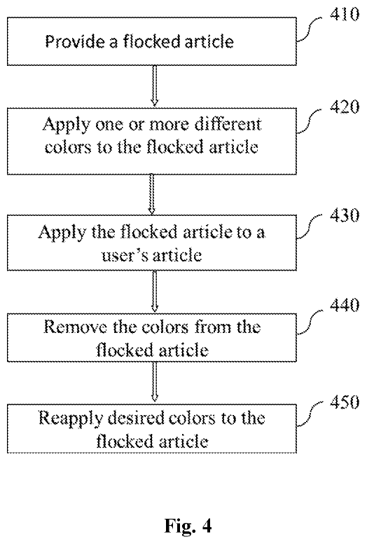

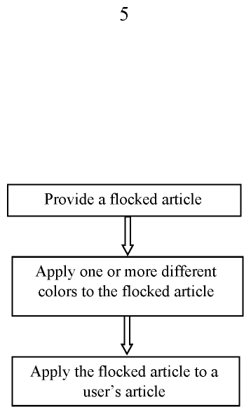

FIG. 4 shows another method according to an exemplary embodiment of the present invention. At step 410, the flocked article can be provided to a user. The user can then fill one or more desired colors to one or more design templates of the flocked article, at step 420. Thereafter, at step 430, the flocked article can be applied to the user's article. The user can have a choice to remove the applied colors and reapply different colors to the flocked article. At step 440, the flocked article can be subjected to a treatment for removing the applied colors from the flocked article. The treatment can be removing the color using an alcoholic solvent or washing the flocked article with a detergent. Thereafter, at step 450, a different color or set of colors can be applied to the flocked article.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A flocked article comprising:
a base layer having a top surface and a rear surface; and
a flocked design layer embedded to the top surface of the base layer, wherein the top surface of the base layer adapted to receive a color, the flocked design layer having at least one design template into which the color can be applied.

2. The flocked article of claim 1, wherein the flocked article further comprises:
an adhesive layer coupled to the rear surface of the base layer; and
a release liner coupled to the adhesive layer, wherein the release liner can be removed to expose the adhesive layer.

3. The flocked article of claim 1, wherein the top surface of the base layer is adapted to removably receive the color.

4. The flocked article of claim 1, wherein the base layer is made of fabric.

5. The flocked article of claim 2, wherein the adhesive layer comprises a heat-sensitive adhesive.

6. The flocked article of claim 2, wherein the adhesive layer comprises a pressure-sensitive adhesive.

7. The flocked article of claim 1, wherein the design template is a line drawing.

8. The flocked article of claim 1, wherein the design template is of a shape selected from a group consisting of landscape, animal, cartoon character, and celestial body.

9. The flocked article of claim 1, wherein the at least one design template is flocked to the base layer.

10. A method personalizing a user's article, the method comprising:
providing a flocked article, the flocked article comprises:
a base layer having a top surface and a rear surface,
a flocked design layer embedded to the top surface of the base layer, wherein the top surface of the base layer adapted to receive a color, the flocked design layer having at least one design template into which the color can be applied;
applying a color to the at least one design template; and
coupling the flocked article to a user's article.

11. The method of claim 10, wherein the method further comprising:
removing the applied color from the at least one design template; and
re-applying a different color to the at least one design template.

12. The method of claim 10, wherein the user's article is a clothing article.

13. The method of claim 10, wherein the user's article is a bag.

14. The method of claim 10, wherein the user's article is a hat.

15. The method of claim 11, wherein the color is removed by a detergent.

16. The method of claim 11, wherein the color is removed by an alcoholic solvent.

17. The method of claim 10, wherein the flocked article further comprises an adhesive layer coupled to the rear surface of the base layer, wherein the flocked article is applied to the user's article through the adhesive layer.

18. The method of claim 10, wherein the base layer is made of fabric.
